(19) United States
(12) Patent Application Publication
(10) Pub. No.: US 2017/0066947 A1
(43) Pub. Date: Mar. 9, 2017

(54) PRIMER FOR ENHANCING TAPE ADHESION TO HYDROPHILIC SURFACES

(71) Applicant: TESA SE, Norderstedt (DE)

(72) Inventors: Sebastian DIETZE, Hamburg (DE); Kai ELLRINGMANN, Hamburg (DE); Marco KUPSKY, Quickborn (DE); Uwe SCHÜMANN, Pinneberg (DE)

(73) Assignee: TESA SE, Norderstedt (DE)

(21) Appl. No.: 15/308,136

(22) PCT Filed: Apr. 20, 2015
(86) PCT No.: PCT/EP2015/058495

§ 371 Date: Nov. 1, 2016

(30) Foreign Application Priority Data
May 9, 2014 (DE) 10 2014 208 814.3

(51) Int. Cl. C09J 133/08; C09J 7/02; C09J 5/00; C08K 5/057; C08K 5/5419

(52) U.S. Cl. CPC C09J 133/08; C08K 5/057; C08K 5/5419; C09J 5/00; C09J 7/02; C09J 2433/003

(57) ABSTRACT

Primer comprising a mixture G, in dispersion or solution in one or more solvents, of at least one copolymer obtained by copolymerizing a monomer mixture comprising at least 90 wt % of the following monomers: vinylcaprolactam and/or vinylpyrrolidone and one or more monomers a) and/or b): a) acrylic esters of a linear, primary alcohol having 2 to 10 carbon atoms in the alkyl radical of the alcohol, b) acrylic esters of a branched non-cyclic alcohol having 3 to 12 carbon atoms in the alkyl radical of the alcohol, at least one organofunctional silane of the general structure (I): (R¹O—)ₓSi(R²)_{y}(R³)_{z}, at least one metal compound selected from the group consisting of metal acetylacetonates, metal alkoxides and alkoxy-metal acetylacetonates.

This is a 371 of PCT/EP2015/058495 filed 20 Apr. 2015, which claims foreign priority benefit under 35 U.S.C. 119 of German Patent Application 10 2014 208 814.3 filed May 9, 2014, the entire contents of which are incorporated herein by reference.

The present invention relates to the technical field of primers for improving the adhesion of adhesive tapes to hydrophilic surfaces, such as to glass surfaces. Proposed in particular is a primer composition for improving the adhesion of polyacrylate-based adhesive tapes, which may comprise pigments or other functional, fillerlike substances in high concentration, without thereby substantially impairing the adhesion-promoting effect.

### BACKGROUND OF THE INVENTION

Primers, often also called adhesion promoters, are widely known in the form of commercial products or from the technical literature. A review of the substances or classes of substance which can be used in primer formulations is found in J. Bielemann, Lackadditive (1998), section 4.3., pp. 114-129.

Primer compositions are disclosed in a multitude of patents, though only a few specifications describe primers whose purpose is to improve adhesion of adhesive tapes.

In the specification WO 2008/094721 A1, in connection with adhesive tape applications, a primer composition is proposed that is based on a maleic anhydride-modified polyolefin and an organic diamine, the intention therewith being to improve adhesion to polyolefin-based materials.

JP 2008-156566 A discloses, for adhesive tape applications, a primer composition based on an acidic acrylate polymer and a fluorine-containing copolymer.

To improve the adhesion of an adhesive tape to substrates treated with melamine resin, WO 02/100961 A1 proposes a primer composition which comprises an acrylate copolymer grafted with an aminoalkyl group containing terminal primary amino groups, an acrylate copolymer having carboxyl groups in the molecular chain, and a solvent.

WO 03/052021 A1 describes a primer composition which comprises a polydiorganosiloxane-polyurea copolymer with electron-rich groups, which may take the form of a primer, an adhesive, a pressure sensitive adhesive, or another coating material. This primer composition as well is identified in connection with adhesive tape applications.

Specifications EP 833 865 B1, EP 833 866 B1, EP 739 383 B1 and U.S. Pat. No. 5,602,202 describe primer compositions which are based on mixtures of styrene/diene block copolymers or styrene/hydrogenated diene block copolymers and selected polyacrylates, whose aim is to improve the adhesion of double-sidedly adhesive, foamed adhesive tapes to both low-energy and higher-energy surfaces.

A primer which is suitable for improving the adhesion of adhesive tapes to substrates where bondability is difficult, particularly to galvanized steel, and also to thermoplastic, olefin-based elastomers such as PP/EPDM, for example, is disclosed in DE 10 2011 077 510 A1.

None of the cited specifications, however, is concerned with promoting adhesion to glass.

Frequently employed for promoting adhesion to hydrophilic substrates such as glass, for example, are silane primers or silane adhesion promoters. Such agents are described for example in DE 10 2009 007 930 A1 or in DE 10 2007 030 196 A1, and additionally in EP 577 014 A1, EP 1 693 350 A1, EP 1 730 247 A1, US 2008 0245 271 A, US 2008 023 425 A, or WO 2008/025846 A2.

The systems disclosed in the cited specifications, however, are not designed for improving the adhesion of adhesive tapes to glass. Accordingly, they contain no components suitable for improving the adhesion to a pressure sensitive adhesive, more particularly the adhesion to a pressure sensitive adhesive based on a copolymer of acrylic esters and, optionally, acrylic acid.

There is additionally need for improvement when the desire is to incorporate pigments or other functional fillers into the primer in high concentration. The very low-viscosity dispersions, solutions or preparations in the cited specifications are oftentimes rarely capable of accommodating such fillers.

U.S. Pat. No. 6,646,048 B2 discloses a primer composition composed of a reactive acrylic resin which consists of two different methacrylates, a silane compound, an epoxy resin of the bisphenol A type, and carbon black. This primer composition of a reactive acrylic resin and a silane is indeed suitable for improving the adhesion of a urethane-based sealant or of a reactive adhesive to glass, but must be regarded as unsuitable for improving the adhesion of a pressure sensitive adhesive tape to glass. In contrast to a urethane-based sealant and to a reactive adhesive, which are able still to crosslink even after application and so are able to enter into a chemical bond with the primer, the polymer base of the pressure sensitive adhesives is no longer reactive during application of the adhesive tape. The primer composition of U.S. Pat. No. 6,646,048 B2, therefore, does not achieve an improvement in adhesion between an adhesive tape and a glass substrate.

The problem addressed by the invention is, generally, the provision of a primer for improving the adhesion of adhesive tapes to hydrophilic surfaces such as, in particular, glass or ceramic. The primer here is intended preferably to allow the incorporation of pigments or other functional fillers in high concentration, without thereby significantly reducing the adhesion-promoting effect of the primer. It is to be possible to incorporate pigments into the primer at such a high concentration that opacity is achieved when this primer is applied in a thin film to glass. The term “thin film” here refers to a film thickness of the order of between approximately 5 μm and 20 μm. Opaque means that it ought not to be possible to see through the primer layer, and therefore that visible light ought not to shine through the primer layer.

The adhesion-promoting effect of the primer is to be built up rapidly. An adhesive tape adhered to the primer layer is in particular to be no longer detachable after just 24 hours from the primer layer applied to a glass or ceramic surface.

Furthermore, the primer ought to be designed in such a way that an adhesive tape can be adhered to the primer layer just a short time after the primer has been applied to the substrate surface, particularly to glass. Even shortly after application, therefore, the primer is to be “dry”, meaning that the solvent is to have evaporated after just a short time. A short time here refers to a period of 60 seconds, preferably 40 seconds.

Furthermore, the primer is to be free from halogen-containing, and especially chlorine-containing, substances.

### SUMMARY OF THE INVENTION

The problem is solved by the subject of the invention. The subject of the invention in a first and general embodiment is a primer which comprises a mixture G which is dispersed or dissolved in one or more solvents and comprises
at least one copolymer obtained by copolymerization, preferably radical copolymerization, of a monomer mixture which comprises to an extent of at least 90 wt % the following monomers: vinylcaprolactam and/or vinylpyrrolidone and one or more of the monomers a) and/or b):
a) acrylic esters of a linear, primary alcohol having 2 to 10 carbon atoms in the alkyl radical of the alcohol,
b) acrylic esters of a branched, noncyclic alcohol having 3 to 12 carbon atoms in the alkyl radical of the alcohol,
at least one organofunctional silane of the general structure (I)

(R¹O—)ₓSi(R²)_{y}(R³)_{z} (I), in which
the radicals R¹ independently of one another are a C₁-C₄ alkyl radical, a C₂-C₆ alkoxyalkyl radical or an acetyl radical;
the radical R² is an aminoalkyl radical, a vinyl group, a methacryloyloxyalkyl radical, an isocyanatoalkyl radical, an O-methylcarbamatoalkyl radical, a glycidyloxyalkyl radical or a phenyl radical;
the radicals R³ independently of one another are a C₁-C₁₈ alkyl radical, and
x=1, 2 or 3; y=0 or 1, and z=4−x−y;
at least one metal compound selected from the group consisting of metal acetylacetonates, metal alkoxides, and alkoxy-metal acetylacetonates.

“Vinylcaprolactam” refers to N-vinylcaprolactam (CAS No. 2235-00-9) and “vinylpyrrolidone” refers to N-vinyl-2-pyrrolidone (CAS No. 88-12-0).

A metal acetylacetonate in accordance with the invention is a coordination compound composed of acetylacetonate anions and metal cations. The general formula is as follows: M(acac)ₘ. M here is a metal cation, and acac is the acetylacetonate anion. The IUPAC name for acetylacetone is as follows: pentane-2,4-dione, and the CAS No. is as follows: 123-54-6. m is the number of acetylacetonate anions which are necessary for charge compensation. m is dependent on the oxidation state of the metal cation.

The term “metal alkoxide” is a synonym for “metal alcoholate”. It relates to coordination compounds of the general formula: M(OR)ₙ. M here is a metal cation, and OR is an alkoxide anion. R is an alkyl radical. n is the number of alkoxide anions which are necessary for charge compensation. n is dependent on the oxidation state of the metal cation.

Alkoxy-metal acetylacetonates are understood in this specification to be mixed coordination compounds composed of acetylacetonate anions and alkoxide anions and of metal cations. The general formula is as follows: M(acac)ₘ(OR)ₙ. M here is a metal cation, acac the acetylacetonate anion, and OR an alkoxide anion. R is an alkyl radical. m and n are the number of acetylacetonate anions and alkoxide anions, respectively, which are necessary for charge compensation. m and n are dependent on the oxidation state of the metal cation.

Primers of the invention exhibit strong adhesion to hydrophilic substrates such as, in particular, glass or ceramic, on the one hand, and to adhesive tapes, especially those with polar pressure sensitive adhesives, as for example with pressure sensitive adhesives based on polyacrylic esters, on the other. Accordingly, primers of the invention are excellent adhesion promoters for bonds of adhesive tapes to glass and ceramic.

The adhesion-promoting effect of a primer of the invention here begins very rapidly. It has been found that an adhesive tape adhered to the primer layer could no longer be detached without destruction from the primer layer applied to a glass or ceramic surface just a short time after adhesion, as for example after approximately 30 minutes.

It is possible, furthermore, for a primer of the invention to be filled with pigments or other functional fillers without thereby reducing its adhesion-promoting effect to any performance relevant extent. Moreover, the rate at which the adhesion-promoting effect begins and develops is hardly impaired by the addition of pigments or other functional fillers. As has been found, this is even the case when the pigments or other functional fillers are present in the primer layer at such a high concentration that the primer layer, when applied in a thickness of around 5-20 μm to glass, is impervious to light, in other words opaque. The required concentration of the pigments in this case, depending on pigment, is between 50 and 200 wt %, based on the total weight of the copolymers.

### DETAILED DESCRIPTION

A primer in accordance with the invention and in agreement with DIN EN ISO 4618 is a coating material for producing a primer coating. In general a primer or coating material is applied to the surface of a substrate, followed by formation of a film through evaporation of a solvent and/or through another chemical or physical curing or film-forming process, after which a further, different substance can be applied to the film thus produced, such as a paint, an ink, an adhesive or an adhesive tape, for example. A fundamental requirement for an adhesion-promoting effect on the part of a primer is firstly that the primer layer adheres effectively to the substrate, the surface of which is also referred to as the base, and secondly that the further, different substance for application to the primer layer produced likewise adheres effectively to said layer. A primer has an optimum adhesion-promoting effect when, in an attempt to peel off the substance applied to the primer, or the adhesive product applied to the primer, the result is cohesive failure within the substance, the adhesive product or the adhesive tape, or when the substrate to which the primer has been applied beforehand is destroyed in this process. If the forces required to peel off the substance, adhesive product, or adhesive tape applied to the primer are higher than if no primer is used, there is an improvement in adhesion or an improvement in the adhesion force. The greater these forces, the stronger the improvement in adhesion or improvement in the adhesion force.

A solvent in the sense of the invention is any known liquid which is suitable for dissolving or at least finely dividing the mixture disclosed in the main claim, without entering into an unwanted chemical reaction with the substances according to the invention in this mixture. Preferred solvents of the invention are organic solvents, as for example esters, ketones, and aliphatic and aromatic hydrocarbons. Particularly preferred solvents are those having a boiling point of less than or equal to 100° C. Especially preferred are solvents whose boiling point is less than 80° C., more particularly ethyl acetate with CAS No. 141-78-6 and acetone (CAS No. 67-64-1).

Mixtures of the solvents of the invention are included in the concept of the invention.

Water and other inorganic solvents are likewise included in the concept of the invention.

A dispersed mixture in accordance with the invention is a finely divided, homogeneous mixture. The degree of fine division and homogeneity is not strictly defined, but must be sufficient for a coherent layer to be formed after coating, and for the size of the aggregates or agglomerates not dissolved at a molecular level to be sufficiently low that the function of the primer layer as, for example, an adhesion-promoting layer is ensured.

The mixture G present in the primer of the invention preferably comprises at least one copolymer obtained by radical copolymerization of the following monomers: vinylcaprolactam and/or vinylpyrrolidone and one or more of the following monomers a) and/or b):
a) acrylic esters of a linear, primary alcohol having 2 to 10 carbon atoms in the alkyl radical of the alcohol,
b) acrylic esters of a branched, noncyclic alcohol having 3 to 12 carbon atoms in the alkyl radical of the alcohol,
   where the sum of vinylcaprolactam and vinylpyrrolidone and also of the monomers a) and b) makes up preferably 100 wt % of the copolymer—and of each copolymer where there are two or more.

The at least one copolymer of the mixture G of the primer of the invention is preferably a pressure sensitive adhesive. More preferably all copolymers present in the mixture G are pressure sensitive adhesives.

A pressure sensitive adhesive is understood in accordance with the invention, as is customary within the general usage, as a material which—in particular at room temperature—is permanently tacky and also adhesive. Characteristics of a pressure sensitive adhesive are that it can be applied by pressure to a substrate and remains adhering there, with no further definition of the pressure to be applied or the period of exposure to this pressure. In certain cases, depending on the precise nature of the pressure sensitive adhesive, the temperature, and the atmospheric humidity and also the substrate, a minimal pressure of short duration, which does not go beyond gentle contact for a brief moment, is enough to achieve the adhesion effect, while in other cases a longer-term period of exposure to a high pressure may be necessary.

Pressure sensitive adhesives have particular, characteristic viscoelastic properties which result in the permanent tack and adhesiveness. A characteristic of these adhesives is that when they are mechanically deformed, there are processes of viscous flow and there is also development of elastic forces of recovery. The two processes have a certain relationship to one another in terms of their respective proportion, in dependence not only on the precise composition, the structure, and the degree of crosslinking of the pressure sensitive adhesive, but also on the rate and duration of the deformation, and on the temperature.

The proportional viscous flow is necessary for the achievement of adhesion. Only the viscous components, brought about by macromolecules with relatively high mobility, permit effective wetting and effective flow onto the substrate where bonding is to take place. A high viscous flow component results in high tack (also referred to as surface stickiness) and hence often also in a high peel adhesion. Highly crosslinked systems, crystalline polymers, or polymers with glasslike solidification lack flowable components and are therefore in general devoid of tack or possess only little tack at least.

The proportional elastic forces of recovery are necessary for the attainment of cohesion. They are brought about, for example, by very long-chain macromolecules with a high degree of coiling, and also by physically or chemically crosslinked macromolecules, and they allow the transmission of the forces that act on an adhesive bond. As a result of these forces of recovery, an adhesive bond is able to withstand a long-term load acting on it, in the form of a long-term shearing load, for example, sufficiently over a relatively long time period.

For the more precise description and quantification of the extent of elastic and viscous components, and also of the relationship between the components, it is possible to employ the variables of storage modulus (G′) and loss modulus (G″), which can be determined by means of Dynamic Mechanical Analysis (DMA). G′ is a measure of the elastic component, G″ a measure of the viscous component, of a substance. Both variables are dependent on the deformation frequency and the temperature.

The variables can be determined with the aid of a rheometer. In that case, for example, the material under investigation is exposed in a plate/plate arrangement to a sinusoidally oscillating shearing stress. In the case of instruments operating with shear stress control, the deformation is measured as a function of time, and the time offset of this deformation is measured relative to the introduction of the shearing stress. This time offset is referred to as phase angle δ.

The storage modulus G′ is defined as follows: G′=(τ/γ)·cos(δ) (τ=shear stress, γ=deformation, δ=phase angle=phase shift between shear stress vector and deformation vector). The definition of the loss modulus G″ is as follows: G″=(τ/y)·sin(δ) (τ=shear stress, γ=deformation, δ=phase angle=phase shift between shear stress vector and deformation vector).

A substance is considered in general to be a pressure sensitive adhesive, and is defined as being pressure-sensitively adhesive for the purposes of this specification, if at room temperature, presently by definition 23° C., in the deformation frequency range from 10⁰ to 10¹ rad/sec, G′ is located at least partly in the range from 10³ to 10⁷ Pa and if G″ likewise is located at least partly within this range. “Partly” means that at least one section of the G′ curve lies within the window described by the deformation frequency range from 10⁰ inclusive up to 10¹ inclusive rad/sec (abscissa) and by the G′ value range from 10³ inclusive up to 10⁷ inclusive Pa (ordinate), and if at least one section of the G″ curve is likewise located within this window.

Pressure sensitive adhesives which comprise vinylcaprolactam and/or vinylpyrrolidone in the copolymer customarily have only average adhesive qualities. It was all the more surprising that in the context of the present invention it has been found that a primer whose pressure sensitive adhesive is a copolymer of the invention having vinylcaprolactam and/or vinylpyrrolidone as monomer components has outstanding adhesion-promoting qualities and produces a very strong bond of adhesive tapes to hydrophilic substrates, especially glass.

More preferably the copolymer is a pressure sensitive adhesive, and the monomer mixture of the copolymer comprises only vinylcaprolactam and/or vinylpyrrolidone and also one or more of the monomers a) and/or b), meaning that the copolymer is synthesized only from these monomers, without other copolymerizable monomers being present. A primer based on such a copolymer has particularly good adhesion-promoting qualities. Furthermore, it is possible advantageously to do without the presence of comonomers—especially plasticizing comonomers—and components other than those stated. Thus, for example, it is possible to do entirely without comonomers having cyclic hydrocarbon units.

Linear acrylic esters having 2 to 10 C atoms in the alkyl radical are ethyl acrylate, n-propyl acrylate, n-butyl acrylate, n-pentyl acrylate, n-hexyl acrylate, n-heptyl acrylate, n-octyl acrylate, n-nonyl acrylate, n-decyl acrylate. Preferably the monomer mixture comprises n-butyl acrylate.

Branched noncyclic acrylic esters having from 3 up to and including 12 carbon atoms in the alkyl radical of the alcohol are preferably selected from the group consisting of 2-ethylhexyl acrylate (EHA), 2-propylheptyl acrylate, isooctyl acrylate, isobutyl acrylate, isoamyl acrylate, and isodecyl acrylate. More preferably the monomers b) are selected from the group consisting of 2-ethylhexyl acrylate (EHA), 2-propylheptyl acrylate, and isooctyl acrylate (more precisely: the acrylic esters in which the alcohol component derives from a mixture of primary isooctanols, in other words from those alcohols obtainable from an isoheptene mixture by hydroformylation and subsequent hydrogenation).

The (monomers a) and b)): (vinylcaprolactam+vinylpyrrolidone) weight ratio is preferably from 95:5 to 40:60, more preferably from 85:15 to 50:50, in particular from 80:20 to 60:40, as for example from 75:25 to 65:35.

Very preferably the monomer mixture consists of vinylcaprolactam and/or vinylpyrrolidone and precisely one monomer of variety a), with n-butyl acrylate being selected more preferably as monomer a). As a further monomer, vinylcaprolactam is particularly preferred. More particularly, therefore, the monomer mixture consists of vinylcaprolactam and n-butyl acrylate. In a monomer mixture of this kind, the n-butyl acrylate:vinylcaprolactam weight ratio is preferably from 95:5 to 50:50, more preferably from 80:20 to 60:40.

In accordance with the invention the monomer mixture may contain up to 10 wt %, based on the total weight of the monomer mixture, of further copolymerizable monomers, in addition to the monomers which are encompassed in any case by the subject matter of the invention. As such further copolymerizable monomers it is possible, without particular restriction, to use all radically polymerizable, C═C double bond-containing monomers or monomer mixtures that are known to the skilled person. By way of example, the further monomers may be selected from the group consisting of the following: methyl acrylate, methyl methacrylate, ethyl methacrylate, benzyl acrylate, benzyl methacrylate, phenyl acrylate, phenyl methacrylate, isobornyl acrylate, isobornyl methacrylate, t-butylphenyl acrylate, t-butylphenyl methacrylate, dodecyl methacrylate, lauryl acrylate, n-undecyl acrylate, stearyl acrylate, tridecyl acrylate, behenyl acrylate, cyclohexyl methacrylate, cyclopentyl methacrylate, phenoxyethyl acrylate, phenoxyethyl methacrylate, 2-butoxyethyl methacrylate, 2-butoxyethyl acrylate, 3,3,5-trimethylcyclohexyl acrylate, 3,5-dimethyladamantyl acrylate, 4-cumylphenyl methacrylate, cyanoethyl acrylate, cyanoethyl methacrylate, 4-biphenylyl acrylate, 4-biphenylyl methacrylate, 2-naphthyl acrylate, 2-naphthyl methacrylate, tetrahydrofurfuryl acrylate, maleic anhydride, hydroxyethyl acrylate, hydroxypropyl acrylate, hydroxyethyl methacrylate, hydroxypropyl methacrylate, 6-hydroxyhexyl methacrylate, allyl alcohol, glycidyl acrylate, glycidyl methacrylate, 2-butoxyethyl acrylate, 2-butoxyethyl methacrylate, methyl 3-methoxy acrylate, 3-methoxybutyl acrylate, phenoxyethyl acrylate, phenoxyethyl methacrylate, 2-phenoxyethyl methacrylate, butyl diglycol methacrylate, ethylene glycol acrylate, ethylene glycol monomethyl acrylate, methoxy-polyethylene glycol methacrylate 350, methoxy-polyethylene glycol methacrylate 500, propylene glycol monomethacrylate, butoxydiethylene glycol methacrylate, ethoxytriethylene glycol methacrylate, dimethylaminopropylacrylamide, dimethylaminopropylmethacrylamide, N-(1-methylundecyl)acrylamide, N-(n-butoxymethyl)acrylamide, N-(butoxymethyl)meth-acrylamide, N-(ethoxymethyl)acrylamide, N-(n-octadecyl)acrylamide, and also N,N-dialkyl-substituted amides, such as, for example, N,N-dimethylacrylamide, N,N-dimethylmethacrylamide, N-benzylacrylamides, N-isopropylacrylamide, N-tert-butylacrylamide, N-tert-octylacrylamide, N-methylolacrylamide, N-methylolmethacrylamide, acrylonitrile, methacrylonitrile, vinyl ethers, such as vinyl methyl ether, ethyl vinyl ether, vinyl isobutyl ether, vinyl esters, such as vinyl acetate, vinylpyridine, 4-vinylpyridine, N-vinylphthalimide, styrene, o- and p-methylstyrene, o-butylstyrene, 4-n-butylstyrene, 4-n-decylstyrene, 3,4-dimethoxystyrene, Macromonomers such as 2-polystyrene-ethyl methacrylate (molecular weight MW from 4000 to 13 000 g/mol), poly(methyl methacrylate)ethyl methacrylate (MW from 2000 to 8000 g/mol).

The monomer mixture of the copolymer of the primer of the invention preferably comprises at most 50 wt %, more preferably at most 40 wt %, of vinylcaprolactam and vinylpyrrolidone, based on the total weight of the monomer mixture. Likewise preferably the monomer mixture comprises preferably at least 10 wt %, more preferably at least 20 wt %, more particularly at least 30 wt % of vinylcaprolactam and/or vinylpyrrolidone, based on the total weight of the monomer mixture.

The monomer mixture comprises preferably at most 1 wt %, more preferably at most 0.1 wt %, based on the total weight of the monomer mixture, of acrylic acid. More particularly the monomer mixture is free from acrylic acid.

The concentration of the copolymer or of the entirety of all copolymers of the mixture G, based on the total weight of the primer, is preferably from 1 wt % to 30 wt %, more preferably from 2 wt % to 20 wt %, in particular from 3 wt % to 10 wt %.

In the organofunctional silane of the general structure (I), the radicals R¹ independently of one another are preferably a methyl, ethyl, 2-methoxyethyl or an acetyl radical. The radicals R³ independently of one another are preferably a methyl, isooctyl, hexadecyl or a cyclohexyl radical. The radical R² is preferably an aminoalkyl, glycidyloxyalkyl, vinyl, methacryloyloxymethyl, 3-methacryloyloxypropyl or a phenyl radical, more particularly a 3-glycidyloxy-(n-) propyl or an aminoalkyl radical or a vinyl group.

More preferably the radical R² is a glycidyloxyalkyl radical and y=1. Likewise more preferably the organofunctional silane of the general structure (1) contains an aminoalkyl radical or a vinyl group. The organofunctional silane or silanes of the general structure (I) is or are selected more particularly from the group consisting of 3-glycidyloxypropyltrimethoxysilane (e.g., GENIOSIL® GF 80, Wacker), 3-glycidyloxypropyltriethoxysilane (e.g., GENIOSIL® GF 82, Wacker), N-cyclohexylaminomethyl-methyldiethoxysilane, N-cyclohexylaminomethyltriethoxysilane, N-phenylaminomethyltrimethoxysilane, N-(2-aminoethyl)-3-aminopropyltrimethoxysilane, N-cyclohexyl-3-aminopropyltrimethoxysilane, 3-aminopropyltriethoxysilane, N-(2-aminoethyl)-3-aminopropylmethyldimethoxysilane, 3-aminopropyltrimethoxysilane, vinyltrimethoxysilane, vinyldimethoxymethylsilane, vinyltriethoxysilane, vinyltris(2-methoxyethoxy)silane, and vinyltriacetoxysilane.

Synonyms for “alkoxy-metal acetylacetonate” are metal alkoxide acetylacetonate or metal acetyl acetonate alkoxide. In accordance with the invention the metal compound may carry further ligands without departing from the concept of the invention.

The metal is preferably selected from the group consisting of titanium, aluminum, zirconium, zinc, and iron; more particularly the metal is titanium or zirconium. With particular preference the metal compound is selected from titanium or zirconium alkoxides. Very preferably the metal compound is titanium tetraisopropoxide Ti(iPr)₄.

The weight fraction of the entirety of the metal compounds in the mixture G is preferably greater than the weight fraction of the entirety of the organofunctional silanes of the general structure (I).

Further to the substances identified so far, a primer of the invention may comprise further constituents, examples being additives such as other polymers, resins, plasticizers, stabilizers, rheological additives, fillers, pigments, crosslinkers, initiators, catalysts, accelerators, and the like.

A water scavenger has preferably been admixed to the primer of the invention during its preparation. More preferably tosyl isocyanate (CAS No. 4083-64-1) was admixed to the primer of the invention during its preparation. The fraction of the water scavenger used is preferably 1 to 15 wt %, more preferably 5 to 10 wt %, based on the entirety of all copolymers of the mixture G.

The primer of the invention is preferably free from polymers other than the copolymer(s) of the mixture G, more particularly from chlorinated polyolefins. The primer of the invention advantageously contains no block copolymers of the polystyrene/polydiene or polystyrene/hydrogenated polydiene type. Block copolymers of the polystyrene/polydiene or polystyrene/hydrogenated polydiene type are understood in the sense of this specification to be all polymers whose molecules consist of linked blocks of polystyrene and polydiene units or hydrogenated or part-hydrogenated polydiene units or else comprise such blocks at least in substantial fractions. Typical examples of polydiene units and also hydrogenated or part-hydrogenated polydiene units are polybutadiene, polyisoprene, polymerized ethylene/butylene and ethylene/propylene blocks. Surprisingly it has been found that block copolymers of the polystyrene/polydiene or polystyrene/hydrogenated polydiene type have the disadvantage, as an additional constituent in the primer of the invention, of impairing the adhesion of the primer to hydrophilic surfaces such as, in particular, glass or ceramic, as compared with a primer of the invention without this additional constituent. Moreover, the addition of block copolymers of the polystyrene/polydiene or polystyrene/hydrogenated polydiene type to the primer of the invention necessitates a different, less polar solvent or solvent mixture than would be necessary without such addition. More particularly, the addition of toluene or benzine is necessary in order to obtain a homogeneous primer solution. These solvents, however, have a comparatively high boiling point, and so the desire for a rapid drying time of the primer cannot be met using them.

Likewise preferably the primer of the invention is free from epoxy resins.

The primer of the invention preferably comprises one or more fluorescent optical brighteners. This is advantageous because in this way a primed substrate can be identified. Without optical identification, it is frequently difficult to tell a primed substrate from an unprimed substrate, since the thickness in which a primer is applied is generally very low and is therefore barely perceptible optically. One preferred fluorescent optical brightener is 2,5-thiophenediylbis(5-tert-butyl-1,3-benzoxazole), CAS No. 7128-64-5, available commercially under the trade name Tinopal OB®.

The sum of the weight fractions of the mixture G and of the solvents in the primer of the invention is preferably at least 80%, more preferably at least 85%, more particularly at least 90%, as for example at least 92%, and very preferably at least 95%.

A primer of the invention preferably comprises the following components in the proportions stated, based in each case on the total weight of the primer:
copolymer(s) 3 to 9 wt %
solvent(s) 65 to 90 wt %
silane(s) of the structure (I) 0.5 to 7 wt %
metal compound(s) 2 to 12 wt %
additives 1 to 10 wt %,
   the fractions adding up to 100 wt %.

A further subject of the invention is the use of a primer of the invention for producing an adhesion-promoting layer, preferably for producing an adhesion-promoting layer comprising pigments and/or other functional fillers, more particularly an adhesion-promoting layer comprising carbon black.

A further subject of the invention is a method for producing an adhesion-promoting layer on a substrate, which comprises applying a primer of the invention to a substrate and removing the one or more solvents.

Primers of the invention have excellent adhesion to glass in particular, but also to many other hydrophilic surfaces such as ceramic, for example. Adhesive tapes with polar pressure sensitive adhesives, more particularly with pressure sensitive adhesives based on copolymers of acrylic esters and acrylic acid, exhibit excellent adhesion to a primer of the invention. The excellent adhesion is manifested by the adhesive tape being predominantly detachable only with destruction, in other words with internal adhesive-tape splitting. The adhesion-promoting effect of a primer of the invention begins, surprisingly, very rapidly. An adhesive tape adhered to the primer layer can frequently no longer be detached without destruction from the primer layer applied to a glass or ceramic surface just a short time after bonding, usually after approximately 30 minutes. This means that, through the adhesion-promoting influence of the primer, the adhesive tape has experienced peel increase very rapidly and very strongly. The term “peel increase” is understood by the skilled person to refer to the increase in bond strength on storage of an adhesive assembly composed of substrate and adhesive tape.

Primers of the invention could also be formulated in such a way that an adhesive tape can be detached predominantly only with destruction of the adhesive tape after several weeks of heat-and-humidity storage or cyclical-conditions storage (temperatures from 60° to 90° C. in conjunction with relative humidity of greater than or equal to 80%) of the adhesive assembly, comprising the substrate coated with the primer, and the adhesive tape adhered to said substrate.

Surprisingly it has been found, in the context of the present invention, that the adhesion-promoting effect of the primer is not impaired—at least not measurably so—even when color pigments or other functional fillers, especially mineral fillers, are added to the primer. The rate at which the adhesion-promoting effect begins and develops, and the extent of the effect, are also unaffected by the addition of color pigments or other functional fillers, not even when the color pigments or other functional fillers are present in the primer layer at such a high concentration that the primer layer is impervious to light, in other words opaque, when applied at a thickness of around 5-20 μm to glass. The necessary concentration of the color pigments in this case is between 50 and 200 percent by mass, based on the copolymer, depending on color pigment. Even with this concentration of color pigment or filler in the primer, the adhesion of the adhesive tapes is still good enough for cohesive failure to occur within the adhesive tape in a peel test with adhesive bonds to glass or ceramic, this effect being achieved just 30 minutes after the adhering of the adhesive tape to the primer layer applied to the glass or ceramic surface.

It is possible for the primer of the invention to be furnished with defined functionalities, if functional fillers are to be used. For instance, the primer may not only be colored, as described, if color pigments such as carbon black or titanium dioxide, for example, are added; instead, the primer, furthermore, may also be made electrically or thermally conductive, if metal particles, for example, are added. The pH of the primer may also be adjusted through the choice of the filler, and by this means, for example, an antibacterial effect can be produced by using calcium oxide. Fillers with rheological activity as well, such as fumed silicas, for example, may be used, and so relatively thick, dimensionally stable primer layers, for example, can also be produced. It is possible, furthermore, to lower the costs of the primer without a measurable impairment in performance capacity, by means of a high fraction of inexpensive mineral fillers, such as chalk, for example.

This opens up a wide spectrum of new possible uses for primers. For instance, properties which hitherto had to be realized by means of an adhesive, such as coloring, can now be covered by the primer, leading in turn to the advantage that the demands imposed on the adhesive system are lower.

An adhesion-promoting layer is produced with the primer of the invention in a known way, specifically by application of the primer to a substrate first of all. Thereafter the solvent or solvents is or are caused to evaporate, after which the adhesive tape can be applied. The time between application/evaporation of the solvent and application of the adhesive tape may be just a few minutes, or else several days or weeks.

### EXAMPLES

The test methods below were used to provide brief characterization of the specimens produced in accordance with the invention:

Dynamic Mechanical Analysis (DMA) for Determining the Storage Modulus G′ and the Loss Modulus G″

The pressure-sensitive adhesion of the copolymers in the primer was characterized by determination of the storage modulus G′ and loss modulus G″ by means of dynamic mechanical analysis (DMA).

The measurements were made using the DSR 200 N shear stress-controlled rheometer from Rheometric Scientific in an oscillation test with a sinusoidally oscillating shearing stress in a plate/plate arrangement. The storage modulus G′ and the loss modulus G″ were determined in a frequency sweep from 10⁻¹ to 10² rad/sec at a temperature of 23° C. G′ and G″ are defined as follows:

G′=τ/γ·cos(δ)

(τ=shear stress, γ=deformation, δ=phase angle=phase shift between shear stress vector and deformation vector).

G″=τ/γ·sin(δ)

(τ=shear stress, γ=deformation, δ=phase angle=phase shift between shear stress vector and deformation vector).

The definition for the angular frequency is as follows: ω=2π·f (f=frequency). The unit is rad/sec.

The thickness of the pressure-sensitive adhesive (PSA) copolymer samples measured was always between 0.9 and 1.1 mm (1+/−0.1 mm). The PSA copolymer samples were produced by coating out the copolymers described later on below on a double-sidedly siliconized polyester film (release liner), evaporating the solvent at 70° C., and piling up the resulting 100 μm coats on one another until a thickness of about 1 mm was reached. The sample diameter was 25 mm in each case. Preliminary tension was applied with a load of 3 N. For all of the measurements, the stress of the sample specimens was 2500 Pa.

Peel Adhesion

The peel adhesion was determined in accordance with PSTC-101 at room temperature. In line with this method, the primer was first applied thinly to the substrate. This was done by brush application of the primer to the substrate. Following evaporation of the solvent, the adhesive strip under measurement (the adhesive tape) was applied (adhered) to the substrate now bearing the primer in a layer thickness of approximately 1 μm to 10 μm. To effect this application, a strip of the adhesive tape in a defined width (standard: 20 mm) was bonded to the primer-coated substrate, with dimensions of 50 mm×125 mm×1.1 mm, by rolling over it ten times with a 5 kg steel roller.

The time between the last rollover of the adhesive tape and the peel removal was as follows: a) 30 minutes; b) 3 days. The peel angle was 90° in each case and the peel rate 300 mm/min. The force required for peel removal is the peel adhesion, which is reported in the unit N/cm and thus relates to a standardized adhesive tape width of 1 cm. Alongside the peel adhesion, the nature of adhesive bond failure was ascertained. The adhesive strips measured were reinforced on the reverse with a polyester film that was 23 μm thick and had undergone incipient etching with trichloroacetic acid. All measurements were conducted in a controlled-climate space at 23° C. and 50% relative humidity.

Conditioned Storage

The assemblies comprising the substrate coated with the primer of the invention and the adhesive tape adhered to that substrate were subjected to storage under selected climatic conditions, in order to determine the climatic robustness of the bond.

Storage a): two-week storage under conditions of 85° C. and 85% relative humidity

Storage b): two-week alternating storage with cycles of 4 hours −40° C., 4 hours heating/cooling, 4 hours 80° C./80% relative humidity.

After the end of the storage period, the samples, which were reinforced on the reverse with a polyester film having a thickness of 23 μm and having been incipiently etched with trichloroacetic acid, were subjected to the peel adhesion test with a peel angle of 90° in each case and with a peel rate of 300 mm/min, in a controlled-climate space at 23° C. and 50% relative humidity.

Transmission Measurement with UV/VIS Spectrometer

The light transmittance was measured using the UVIKON 923 UV/VIS spectrometer from Kontron, in the wavelength range from 190 to 850 nm.

Static Glass Transition Temperature

The static glass transition temperature is determined via differential scanning calorimetry in accordance with DIN 53765. The figures for the glass transition temperature T_{g} refer to the glass transformation temperature value T_{g} in accordance with DIN 53765:1994-03, unless indicated otherwise in any specific case. Heating curves run with a heating rate of 10 K/min. The specimens are measured in Al crucibles with a perforated lid under a nitrogen atmosphere. Evaluation takes place on the second heating curve. A glass transition temperature is evident as an inflection point on the thermogram.

Molecular Weights

The average molecular weight M_{w} and the average molecular weight M_{N}, and the polydispersity D, were determined by means of gel permeation chromatography (GPC). The eluent used was THF with 0.1 vol % of trifluoroacetic acid.

Measurement took place at 25° C. The preliminary column used was a PSS-SDV, 5 μm, 10³ Å (10⁻⁷ m), ID 8.0 mm×50 mm. Separation took place using the columns PSS-SDV, 5 μm, 10³ Å, (10⁻⁷ m), 10⁵ Å (10⁻⁵ m), and 10⁶ Å (10⁻⁴ m), each with ID 8.0 mm×300 mm. The sample concentration was 4 g/l, the flow rate 1.0 ml per minute. Measurement took place against PMMA standards.

Solids Content

The solids content is a measure of the fraction of unvaporizable constituents in a polymer solution. It is determined gravimetrically, with the solution being weighed, the vaporizable fractions then being evaporated off in a drying cabinet at 120° C. for 2 hours, and the residue being weighed again.

K Value (Fikentscher)

The K value is a measure of the average molecular size of high-polymer compounds. For the measurement, one percent strength (1 g/100 ml) toluenic polymer solutions were prepared and their kinematic viscosities were determined by means of a Vogel-Ossag viscometer. Standardization to the viscosity of toluene gives the relative viscosity, from which the K value can be calculated by the method of Fikentscher (Polymer 8/1967, 381 ff.).

The substrates used (to which the primer was applied first of all, followed by the adhesive tape being adhered thereto) were as follows:
a) Glass test bodies (from Rocholl GmbH)
b) Ceramic tiles (from home improvement store)

The adhesive tapes (test adhesive tapes) with which the primer was tested were based on polyacrylate PSAs. These polyacrylate PSAs were prepared using the following raw materials:

| | | Manufacturer or | |
|---|---|---|---|
| Chemical compound | Trade name | supplier | CAS No. |
| Bis(4-tert-butylcyclohexyl) | Perkadox 16 | Akzo Nobel | 15520-11-3 |
| peroxydicarbonate | | | |
| 2,2′-Azobis(2- | Vazo 64 | DuPont | 78-67-1 |
| methylpropionitrile), AIBN | | | |
| 2,2′-Azobis(2- | Vazo 67 | DuPont | 13472-08-7 |
| methylbutyronitrile) | | | |
| Pentaerythritol | Polypox R16 | UPPC AG | 3126-63-4 |
| tetraglycidyl ether | | | |
| 3,4- | Uvacure 1500 | Cytec Industries | 2386-87-0 |
| Epoxycyclohexylmethyl | | Inc. | |
| 3,4- | | | |
| epoxycyclohexanecarboxylate | | | |
| Triethylenetetramine | Epikure 925 | Hexion Speciality | 112-24-3 |
| | | Chemicals | |
| Microbelloons (MB) | Expancel 051 | Expancel Nobel | |
| (dry unexpanded | DU 40 | Industries | |
| microspheres, diameter 9 | | | |
| to 15 μm, expansion onset | | | |
| temperature 106 to 111° C., | | | |
| TMA density ≦25 kg/m³) | | | |
| Terpene-phenolic resin | Dertophene T110 | DRT resins | 25359-84-6 |
| (softening point 110° C., M_{w} = | | | |
| 500 to 800 g/mol, D = | | | |
| 1.50) | | | |
| Acrylic acid n-butyl ester | n-butyl acrylate | Rohm & Haas | 141-32-2 |
| Acrylic acid | acrylic acid, pure | BASF | 79-10-7 |
| 2-Ethylhexyl acrylate | | Brenntag | 103-11-7 |
| Methyl acrylate | | BASF | 96-33-3 |

The expansion capacity of the microballoons can be described through the determination of the TMA density [kg/m³] (Stare Thermal Analysis System from Mettler Toledo; heating rate 20° C./min). The TMA density here is the minimum achievable density at a defined temperature Tₘₐₓ under atmospheric pressure before the microballoons collapse.

The softening point of the resins is determined in accordance with DIN ISO 4625.

Furthermore, the following solvents were used for preparing the polyacrylate PSAs contained in the test adhesive tapes:

| Designation | CAS No. | Manufacturer |
|---|---|---|
| Special-boiling-point spirit 60/95 or | 64742-49-0 | Shell, Exxon |
| naphtha (crude oil), hydrogen-treated, | | |
| light | | |
| Acetone | 67-64-1 | Shell |
| Isopropanol | 67-63-0 | Shell |

Test Adhesive Tape 1

An example polyacrylate PSA 1 for producing the test adhesive tape 1 was prepared as follows: A reactor conventional for radical polymerizations was charged with 54.4 kg of 2-ethylhexyl acrylate, 20.0 kg of methyl acrylate, 5.6 kg of acrylic acid, and 53.3 kg of acetone/isopropanol (94:6). After nitrogen gas had been passed through the reactor for 45 minutes, with stirring, the reactor was heated to 58° C. and 40 g of Vazo 67, in solution in 400 g of acetone, were added. Thereafter the external heating bath was heated to 75° C. and the reaction was carried out constantly at this external temperature. After 1 hour a further 40 g of Vazo 67, in solution in 400 g of acetone, were added, and after 4 hours the batch was diluted with 10 kg of acetone/isopropanol mixture (94:6).

After 5 hours and again after 7 hours, initiation was repeated with 120 g each time of bis(4-tert-butylcyclohexyl) peroxydicarbonate, in each case in solution in 400 g of acetone. After a reaction time of 22 hours, the polymerization was discontinued and the batch was cooled to room temperature. The product had a solids content of 55.9% and was freed from the solvent in a concentrating extruder under reduced pressure (residual solvent content 0.3 mass percent). The resulting polyacrylate had a K value of 58.8, an average molecular weight of Mw=746 000 g/mol, a polydispersity of D (Mw/Mn)=8.9, and a static glass transition temperature of T_{g}=−35.6° C.

This base polymer was melted in a feeder-extruder (single-screw conveying extruder from TROESTER GmbH & Co. KG, Germany) and in the form of a polymer melt was conveyed with said extruder, via a heatable hose, into a planetary roller extruder from Entex (Bochum). The melted resin Dertophene T 110 was then added via a metering port, to give the melt a resin concentration of 28.3 mass percent. Additionally, the crosslinker Polypox R16 was added. Its concentration in the melt was 0.14 mass percent. All components were mixed to give a homogeneous polymer melt.

Using a melt pump and a heatable hose, the polymer melt was transferred to a twin-screw extruder (from Berstorff). There the accelerator Epikure 925 was added. Its concentration in the melt was 0.14 mass percent. The entire polymer mixture was then freed from all gas inclusions in a vacuum dome under a pressure of 175 mbar. After the vacuum zone, the microballoons were metered in and were incorporated homogeneously into the polymer mixture by means of a mixing element. Their concentration in the melt was 0.7 mass percent. The resulting melt mixture was transferred into a die.

Following exit from the die, in other words after a drop in pressure, the incorporated microballoons underwent expansion, with the drop in pressure producing shear-free cooling of the polymer composition. This gave a foamed polyacrylate PSA, which was subsequently shaped to web form in a thickness of 0.8 mm by means of a roll calender, and was lined with a double-sidedly siliconized release film (50 μm, polyester), while the chemical crosslinking reaction proceeded. After winding, the film was stored at room temperature for four weeks before being used further for primer testing. The wound film is test adhesive tape 1.

Test Adhesive Tape 2

An example polyacrylate PSA 2A for producing the middle layer of the three layer test adhesive tape 2 was prepared as follows:

A reactor conventional for radical polymerizations was charged with 30.0 kg of 2-ethylhexyl acrylate, 67.0 kg of butyl acrylate, 3.0 kg of acrylic acid, and 66.7 kg of acetone/isopropanol (96:4). After nitrogen gas had been passed through the reactor for 45 minutes, with stirring, the reactor was heated to 58° C. and 50 g of Vazo 67, in solution in 500 g of acetone, were added. Thereafter the external heating bath was heated to 70° C. and the reaction was carried out constantly at this external temperature. After one hour a further 50 g of Vazo 67, in solution in 500 g of acetone, were added, and after two hours the batch was diluted with 10 kg of acetone/isopropanol mixture (96:4). After 5.5 hours, 150 g of bis(4-tert-butylcyclohexyl) peroxydicarbonate, in solution in 500 g of acetone, were added; after 6 hours 30 minutes, dilution was repeated with 10 kg of acetone/isopropanol mixture (96:4). After 7 hours, a further 150 g of bis(4-tert-butylcyclohexyl) peroxydicarbonate, in solution in 500 g of acetone, were added, and the heating bath was set to a temperature of 60° C.

After a reaction time of 22 hours, the polymerization was discontinued and the batch was cooled to room temperature. The product had a solids content of 50.2% and was dried. The resulting polyacrylate had a K value of 75.2, an average molecular weight of Mw=1 370 000 g/mol, a polydispersity of D (Mw/Mn)=17.13, and a static glass transition temperature of T_{g}=−38.0° C.

This base polymer was melted in a feeder-extruder (single-screw conveying extruder from TROESTER GmbH & Co. KG, Germany) and in the form of a polymer melt was conveyed with said extruder, via a heatable hose, into a planetary roller extruder from Entex (Bochum). Then the crosslinker Polypox R16 was added via a metering port. Its concentration in the melt was 0.22 mass percent. All components were mixed to give a homogeneous polymer melt.

Using a melt pump and a heatable hose, the polymer melt was transferred to a twin-screw extruder (from Berstorff). There the accelerator Epikure 925 was added. Its concentration in the melt was 0.14 mass percent. The entire polymer mixture was then freed from all gas inclusions in a vacuum dome under a pressure of 175 mbar. After the vacuum zone, the microballoons were metered in and were incorporated homogeneously into the polymer mixture by means of a mixing element. Their concentration in the melt was 2.0 mass percent. The resulting melt mixture was transferred into a die.

Following exit from the die, in other words after a drop in pressure, the incorporated microballoons underwent expansion, with the drop in pressure producing shear-free cooling of the polymer composition. This gave the foamed polyacrylate PSA 2A, which was subsequently shaped to web form in a thickness of 0.8 mm by means of a roll calender, and was lined with a double-sidedly siliconized release film (50 μm, polyester), while the chemical crosslinking reaction proceeded. The wound film was stored at room temperature for a day before further processing (see below).

An example polyacrylate PSA 2B for producing the two outer layers of the three-layer test adhesive tape 2 was prepared as follows:

A 100 l glass reactor conventional for radical polymerizations was charged with 4.8 kg of acrylic acid, 11.6 kg of butyl acrylate, 23.6 kg of 2-ethylhexyl acrylate, and 26.7 kg of acetone/special-boiling-point spirit 60/95 (1:1). After nitrogen gas had been passed through the reactor for 45 minutes, with stirring, the reactor was heated to 58° C. and 30 g of AIBN were added. Thereafter the external heating bath was heated to 75° C. and the reaction was carried out constantly at this external temperature. After a reaction time of 1 hour, a further 30 g of AIBN were added. After 4 hours and again after 8 hours, dilution was carried out with 10.0 kg each time of acetone/special-boiling-point spirit 60/95 (1:1) mixture. To reduce the residual initiators, 90 g portions of bis(4-tert-butylcyclohexyl) peroxydicarbonate were added after 8 hours and again after 10 hours. After a reaction time of 24 hours, the reaction was discontinued and the batch was cooled to room temperature. The polyacrylate was subsequently blended with 0.2 mass percent of the crosslinker Uvacure® 1500, diluted to a solids content of 30% with acetone, and subsequently coated from solution onto a double-sidedly siliconized release film (50 μm, polyester). (Coating speed 2.5 m/min, drying tunnel 15 m, temperatures zone 1: 40° C., zone 2: 70° C., zone 3: 95° C., zone 4: 105° C.). The thickness was 50 μm. After winding, the film was stored at room temperature for 2 days, before being used further to produce the test adhesive tape 2.

A film of the polyacrylate PSA 2B was laminated onto both sides of the foamed film of polyacrylate PSA 2A. Immediately prior to the laminating of the film of polyacrylate PSA 2B onto the foamed film of polyacrylate PSA 2A, the respective surface of the film of polyacrylate PSA 2A to be laminated was subjected to air corona pretreatment with a corona dose of 35 Wmin/m². Prior to the second lamination, the double-sidedly siliconized release film of the foamed polyacrylate PSA 2A was lined. After the second lamination, one of the double-sidedly siliconized release films of the two foamed polyacrylate PSAs 2B was lined as well. The 3-layer assembly composed of polyacrylate PSA 2B/polyacrylate PSA 2A/polyacrylate PSA 2B was wound up and stored at room temperature for four weeks before being further used for primer testing. The wound assembly is test adhesive tape 2.

The polyacrylate PSAs described by way of example in terms of their composition and production methodology are described comprehensively in DE 10 2010 062 669. The disclosure content of that specification is incorporated explicitly into the disclosure content of this invention.

To prepare the copolymer present in the primer in accordance with the invention, the following raw materials were used:

| Chemical compound | Trade name | Manufacturer | CAS No. |
|---|---|---|---|
| N-Vinylcaprolactam | | Sigma- | 2235-00-9 |
| | | Aldrich | |
| N-Vinyl-2-pyrrolidone | | Sigma- | 88-12-0 |
| | | Aldrich | |
| Acrylic acid n-butyl ester | n-Butyl | Rohm & | 141-32-2 |
| | acrylate | Haas | |
| 2-Ethylhexyl acrylate | | Brenntag | 103-11-7 |
| Bis(4-tert-butylcyclohexyl) | Perkadox 16 | Akzo Nobel | 15520-11-3 |
| peroxydicarbonate | | | |
| 2,2′-Azobis(2- | Vazo 64 | DuPont | 78-67-1 |
| methylpropionitrile), AIBN | | | |

In addition, the following solvents were used for preparing the copolymer present in accordance with the invention in the primer:

| Designation | CAS No. | Manufacturer |
|---|---|---|
| Special-boiling-point spirit 60/95 or | 64742-49-0 | Shell, Exxon |
| naphtha (crude oil), hydrogen-treated, | | |
| light | | |
| Acetone | 67-64-1 | Shell |

Polyacrylate PSAs for use as a constituent in the primer of the invention were prepared as follows:

Primer PSA 1

A 100 l glass reactor conventional for radical polymerizations was charged with 12.0 kg of N-vinylcaprolactam, 28.0 kg of butyl acrylate, and 26.7 kg of acetone/special-boiling-point spirit 60/95 (1:1). After nitrogen gas had been passed through the reactor for 45 minutes, with stirring, the reactor was heated to 58° C. and 30 g of AIBN were added. Thereafter the external heating bath was heated to 75° C. and the reaction was carried out constantly at this external temperature. After a reaction time of 1 hour, a further 30 g of AIBN were added. After 4 hours and again after 8 hours, dilution took place with 10.0 kg of acetone/special-boiling-point spirit 60/95 (1:1) mixture each time. To reduce the residual initiators, 90 g portions of bis(4-tert-butylcyclohexyl) peroxydicarbonate were added after 8 hours and again after 10 hours. After a reaction time of 24 hours, the reaction was discontinued and the batch was cooled to room temperature. The polyacrylate was diluted to a solids content of 40.0 mass percent with acetone. The resulting solution is primer PSA 1.

Primer PSA 2

A 100 l glass reactor conventional for radical polymerizations was charged with 8.0 kg of N-vinylcaprolactam, 32.0 kg of 2-ethylhexyl acrylate, and 26.7 kg of acetone/special-boiling-point spirit 60/95 (1:1). After nitrogen gas had been passed through the reactor for 45 minutes, with stirring, the reactor was heated to 58° C. and 30 g of AIBN were added. Thereafter the external heating bath was heated to 75° C. and the reaction was carried out constantly at this external temperature. After a reaction time of 1 hour, a further 30 g of AIBN were added. After 4 hours and again after 8 hours, dilution took place with 10.0 kg of acetone/special-boiling-point spirit 60/95 (1:1) mixture each time. To reduce the residual initiators, 90 g portions of bis(4-tert-butylcyclohexyl) peroxydicarbonate were added after 8 hours and again after 10 hours. After a reaction time of 24 hours, the reaction was discontinued and the batch was cooled to room temperature. The polyacrylate was diluted to a solids content of 40.0 mass percent with acetone. The resulting solution is primer PSA 2.

Primer PSA 3

A 100 l glass reactor conventional for radical polymerizations was charged with 8.0 kg of N-vinyl-2-pyrrolidone, 32 kg of butyl acrylate, and 26.7 kg of acetone/special-boiling-point spirit 60/95 (1:1). After nitrogen gas had been passed through the reactor for 45 minutes, with stirring, the reactor was heated to 58° C. and 30 g of AIBN were added. Thereafter the external heating bath was heated to 75° C. and the reaction was carried out constantly at this external temperature. After a reaction time of 1 hour, a further 30 g of AIBN were added. After 4 hours and again after 8 hours, dilution took place with 10.0 kg of acetone/special-boiling-point spirit 60/95 (1:1) mixture each time. To reduce the residual initiators, 90 g portions of bis(4-tert-butylcyclohexyl) peroxydicarbonate were added after 8 hours and again after 10 hours. After a reaction time of 24 hours, the reaction was discontinued and the batch was cooled to room temperature. The polyacrylate was diluted to a solids content of 40.0 mass percent with acetone. The resulting solution is primer PSA 3.

Primer PSA 4 for a Comparative Example

A 100 l glass reactor conventional for radical polymerizations was charged with 15.4 kg of butyl acrylate, 24.4 kg of 2-ethylhexyl acrylate, and 26.7 kg of acetone/special-boiling-point spirit 60/95 (1:1). After nitrogen gas had been passed through the reactor for 45 minutes, with stirring, the reactor was heated to 58° C. and 30 g of AIBN were added. Thereafter the external heating bath was heated to 75° C. and the reaction was carried out constantly at this external temperature. After a reaction time of 1 hour, a further 30 g of AIBN were added. After 4 hours and again after 8 hours, dilution took place with 10.0 kg of acetone/special-boiling-point spirit 60/95 (1:1) mixture each time. To reduce the residual initiators, 90 g portions of bis(4-tert-butylcyclohexyl) peroxydicarbonate were added after 8 hours and again after 10 hours. After a reaction time of 24 hours, the reaction was discontinued and the batch was cooled to room temperature. The polyacrylate was diluted to a solids content of 40.0 mass percent with acetone. The resulting solution is primer PSA 4.

Primer PSAs 1 to 4 were briefly characterized by DMA measurements. The G′ and G″ curves of primer PSAs 1 to 4, in the deformation frequency range from 10⁰ to 10¹ rad/sec at 23° C., were always situated at least partly in the range from 10³ to 10⁷ Pa.

To prepare the primers of the invention, the primer PSAs described above in terms of their preparation and composition, and also the following raw materials, were used:

| | | Manufacturer | |
|---|---|---|---|
| Chemical compound/ | | or | |
| description (manufacturer details) | Trade name | supplier | CAS No. |
| 3- | Geniosil ® | Wacker | 2530-83-8 |
| Glycidoxypropyltrimethoxysilane | GF 80 | Chemie | |
| Vinyltrimethoxysilane | Geniosil ® XL 10 | Wacker | 2768-02-7 |
| | | Chemie | |
| Titanium tetraisopropoxide | Tyzor ® TPT | Lehmann & | 546-68-9 |
| | | Voβ | |
| Tetra-n-butyl titanate | Tyzor ® TnBT | Lehmann & | 5593-70-4 |
| | | Voβ | |
| Bis(acetylacetonato)isobutyl | Tyzor ® AA-95 | Lehmann & | 97281-09-9 |
| isopropyl titanate | | Voβ | |
| Tetra-n-butyl zirconate | Tyzor ® NBZ | Lehmann & | 1071-76-7 |
| | | Voβ | |
| Tosyl isocyanate | Additive TI ® | OMG | 4083-64-1 |
| | | Borchers | |

To prepare two comparative examples, the primers of the invention were modified with the following raw materials:

| Chemical compound/ | | Manufacturer or |
|---|---|---|
| description (manufacturer details) | Trade name | supplier |
| SBS block copolymer | Kraton ® | Kraton Polymers |
| | D 1102 E | |
| Hydrogenated SEBS block | Kraton ® | Kraton Polymers |
| copolymer | G 1652 E | |

Furthermore, in addition to the solvents present in the primer PSAs, the following solvent was used for preparing the primers of the invention:

| Designation | CAS No. | Manufacturer or supplier |
|---|---|---|
| Ethyl acetate | 141-78-6 | Brenntag |

In addition to the solvents present in the primer PSAs, the following solvent was used for preparing two comparative examples:

| Designation | CAS No. | Manufacturer or supplier |
|---|---|---|
| Toluene | 108-88-3 | Sigma-Aldrich |

The following exemplary pigments and functional fillers were incorporated into the primers:

| Chemical | | Manufacturer | |
|---|---|---|---|
| compound/description | | or | |
| (manufacturer details) | Trade name | supplier | CAS No. |
| Furnace black | Printex ® 60 | Orion | 1333-86-4 |
| Furnace black | Printex ® 3 | Orion | 1333-86-4 |
| Copper chromite black | Black 30C965 ® | Shepherd | 68186-91-4 |
| spinel C.I. Pigment | | | |
| Black 28 | | | |

Moreover, in certain cases, the following rheological additives were also used as auxiliaries:

| Description (manufacturer | | Manufacturer or |
|---|---|---|
| details) | Trade name | supplier |
| Thixotropic agent | Disparlon ® | Erbslöh |
| | A 603-20X | |
| Thixotropic agent | Tixogel ® MPZ | Byk |

In addition, the following fluorescent optical brightener was used as well:

| Chemical | | | |
|---|---|---|---|
| compound/description | | Manufacturer | |
| (manufacturer details) | Trade name | or supplier | CAS No. |
| 2,5-Thiophenediylbis(5- | Tinopal OB ® | BASF | 7128-64-5 |
| tert-butyl-1,3-benzoxazole) | | | |

### EXAMPLES

The raw materials/components specified in the examples were mixed with a laboratory agitator from IKA®, using a propeller stirrer, for 20 minutes.

### Example 1

### Primer Composition

| Raw material/component | Mass percent |
|---|---|
| Primer PSA 1 (40.0 mass percent solids | 16.7 |
| fraction) | |
| Ethyl acetate | 72.4 |
| Additive TI ® | 0.5 |
| Geniosil ® GF 80 | 3.1 |
| Tyzor ® TPT | 7.3 |

The primer was tested with the test adhesive tapes, giving the following results:

| | | | | Peel adhesion after | |
|---|---|---|---|---|---|
| | | Peel adhesion | | conditioned storage | |
| | | (300 mm/min) | | (300 mm/min) (N/cm) | |
| Test | | (N/cm) | | a) 2 wks | b) 2 wks |
| adhesive | | after 30 | after 3 | 85° C./85% | climatic |
| tape | Substrate | minutes | days | rel. humidity | cycling |
| 1 | Glass | 64 (C) | 62 (C) | 62 (C) | 59 (C) |
| 1 | Ceramic | 61 (C) | 60 (C) | 59 (C) | 55 (C) |
| | tile | | | | |
| 2 | Glass | 69 (C) | 70 (C) | 60 (C) | 63 (C) |
| 2 | Ceramic | 71 (C) | 71 (C) | 66 (C) | 60 (C) |
| | tile | | | | |

C = cohesive splitting of the adhesive tape

The stated pigments and rheological additives in all examples, in order to produce a finely particulate, opaque primer layer, were incorporated using the Ultra-Turrax® T50 laboratory dissolver from IKA®, operating according to the rotor-stator principle, by first dispersing the pigment and, where appropriate, the other rheological additives into the initially prepared mixture of primer PSA and ethyl acetate, and only then mixing in the remaining raw materials/components. In this operation the Ultra-Turrax® T50 was operated using a rotary speed of 7000 revolutions per minute. The remaining raw materials/components were admixed with the IKA® laboratory agitator, using a propeller stirrer.

The compositions of the primers comprising pigments and, where appropriate, rheological additives, while retaining the fundamental primer composition from example 1, were as follows:

### Example 1a

### Primer Composition

| Raw material/component | Mass percent |
|---|---|
| Primer PSA 1 (40.0 mass percent solids | 16.0 |
| fraction) | |
| Ethyl acetate | 69.5 |
| Additive TI ® | 0.5 |
| Geniosil ® GF 80 | 3.0 |
| Tyzor ® TPT | 7.0 |
| Printex ® 60 | 4.0 |

A layer of this primer 8 μm thick on glass was opaque. The transmittance in the wavelength range from 300 nm to 650 nm was 0%.

The primer was tested in the same way with the same test adhesive tapes as the pigment-free primer from example 1, giving the same results—that is, in all cases the test adhesive tape underwent cohesive splitting.

### Example 1b

### Primer Composition

| Raw material/component | Mass percent |
|---|---|
| Primer PSA 1 (40.0 mass percent solids | 15.1 |
| fraction) | |
| Ethyl acetate | 65.5 |
| Additive TI ® | 0.5 |
| Geniosil ® GF 80 | 2.8 |
| Tyzor ® TPT | 6.6 |
| Black 30C965 ® | 9.0 |
| Disparlon ® A 603-20X | 0.5 |

A layer of this primer 10 μm thick on glass was opaque. The transmittance in the wavelength range from 300 nm to 650 nm was 0%.

The primer was tested in the same way with the same test adhesive tapes as the color pigment-free primer from example 1, giving the same results—that is, in all cases the test adhesive tape underwent cohesive splitting.

### Example 2

### Primer Composition

| Raw material/component | Mass percent |
|---|---|
| Primer PSA 2 (40.0 mass percent solids | 18.8 |
| fraction) | |
| Ethyl acetate | 70.3 |
| Additive TI ® | 0.5 |
| Geniosil ® GF 80 | 3.1 |
| Tyzor ® TPT | 7.3 |

The primer was tested with the test adhesive tapes, giving the following results:

| | | | | Peel adhesion after | |
|---|---|---|---|---|---|
| | | Peel adhesion | | conditioned storage | |
| | | (300 mm/min) | | (300 mm/min) (N/cm) | |
| Test | | (N/cm) | | a) 2 wks | b) 2 wks |
| adhesive | | after 30 | after 3 | 85° C./85% | climatic |
| tape | Substrate | minutes | days | rel. humidity | cycling |
| 1 | Glass | 60 (C) | 60 (C) | 60 (C) | 58 (C) |
| 1 | Ceramic | 62 (C) | 63 (C) | 59 (C) | 57 (C) |
| | tile | | | | |
| 2 | Glass | 70 (C) | 69 (C) | 61 (C) | 62 (C) |
| 2 | Ceramic | 72 (C) | 73 (C) | 60 (C) | 58 (C) |
| | tile | | | | |

C = cohesive splitting of the adhesive tape

The compositions of the primers comprising color pigments and, where appropriate, rheological additives, while retaining the fundamental primer composition from example 2, were as follows:

### Example 2a

### Primer Composition

| Raw material/component | Mass percent |
|---|---|
| Primer PSA 2 (40.0 mass percent solids | 18.0 |
| fraction) | |
| Ethyl acetate | 67.5 |
| Additive TI ® | 0.5 |
| Geniosil ® GF 80 | 3.0 |
| Tyzor ® TPT | 7.0 |
| Printex ® 3 | 4.0 |

A layer of this primer 8 μm thick on glass was opaque. The transmittance in the wavelength range from 300 nm to 650 nm was 0%.

The primer was tested in the same way with the same test adhesive tapes as the color pigment-free primer from example 2, giving the same results—that is, in all cases the test adhesive tape underwent cohesive splitting.

### Example 2b

### Primer Composition

| Raw material/component | Mass percent |
|---|---|
| Primer PSA 2 (40.0 mass percent solids | 17.0 |
| fraction) | |
| Ethyl acetate | 63.6 |
| Additive TI ® | 0.5 |
| Geniosil ® GF 80 | 2.8 |
| Tyzor ® TPT | 6.6 |
| Black 30C965 ® | 9.0 |
| Tixogel ® MPZ | 0.5 |

A layer of this primer 10 μm thick on glass was opaque. The transmittance in the wavelength range from 300 nm to 650 nm was 0%.

The primer was tested in the same way with the same test adhesive tapes as the color pigment-free primer from example 2, giving the same results—that is, in all cases the test adhesive tape underwent cohesive splitting.

### Example 3

### Primer Composition

| Raw material/component | Mass percent |
|---|---|
| Primer PSA 3 (40.0 mass percent solids | 18.8 |
| fraction) | |
| Ethyl acetate | 70.3 |
| Additive TI ® | 0.5 |
| Geniosil ® GF 80 | 3.1 |
| Tyzor ® TPT | 7.3 |

The primer was tested with the test adhesive tapes, giving the following results:

| | | | | Peel adhesion after | |
|---|---|---|---|---|---|
| | | Peel adhesion | | conditioned storage | |
| | | (300 mm/min) | | (300 mm/min) (N/cm) | |
| Test | | (N/cm) | | a) 2 wks | b) 2 wks |
| adhesive | | after 30 | after 3 | 85° C./85% | climatic |
| tape | Substrate | minutes | days | rel. humidity | cycling |
| 1 | Glass | 64 (C) | 65 (C) | 59 (C) | 60 (C) |
| 1 | Ceramic | 63 (C) | 63 (C) | 58 (C) | 62 (C) |
| | tile | | | | |
| 2 | Glass | 68 (C) | 70 (C) | 60 (C) | 64 (C) |
| 2 | Ceramic | 70 (C) | 69 (C) | 61 (C) | 59 (C) |
| | tile | | | | |

C = cohesive splitting of the adhesive tape

The compositions of the primers comprising color pigments and, where appropriate, rheological additives, while retaining the fundamental primer composition from example 3, were as follows:

### Example 3a

### Primer Composition

| Raw material/component | Mass percent |
|---|---|
| Primer PSA 3 (40.0 mass percent solids | 18.0 |
| fraction) | |
| Ethyl acetate | 67.5 |
| Additive TI ® | 0.5 |
| Geniosil ® GF 80 | 3.0 |
| Tyzor ® TPT | 7.0 |
| Printex ® 3 | 4.0 |

A layer of this primer 8 μm thick on glass was opaque. The transmittance in the wavelength range from 300 nm to 650 nm was 0%.

The primer was tested in the same way with the same test adhesive tapes as the color pigment-free primer from example 3, giving the same results—that is, in all cases the test adhesive tape underwent cohesive splitting.

### Example 3b

### Primer Composition

| Raw material/component | Mass percent |
|---|---|
| Primer PSA 3 (40.0 mass percent solids | 17.0 |
| fraction) | |
| Ethyl acetate | 63.6 |
| Additive TI ® | 0.5 |
| Geniosil ® GF 80 | 2.8 |
| Tyzor ® TPT | 6.6 |
| Black 30C965 ® | 9.0 |
| Tixogel ® MPZ | 0.5 |

A layer of this primer 10 μm thick on glass was opaque. The transmittance in the wavelength range from 300 nm to 650 nm was 0%.

The primer was tested in the same way with the same test adhesive tapes as the color pigment-free primer from example 3, giving the same results—that is, in all cases the test adhesive tape underwent cohesive splitting.

### Example 4

### Primer Composition

| Raw material/component | Mass percent |
|---|---|
| Primer PSA 1 (40.0 mass percent solids | 16.8 |
| fraction) | |
| Ethyl acetate | 72.8 |
| Geniosil ® XL 10 | 3.1 |
| Tyzor ® TPT | 7.3 |

The primer was tested with the test adhesive tapes, giving the following results:

| | | | | Peel adhesion after | |
|---|---|---|---|---|---|
| | | Peel adhesion | | conditioned storage | |
| | | (300 mm/min) | | (300 mm/min) (N/cm) | |
| Test | | (N/cm) | | a) 2 wks | b) 2 wks |
| adhesive | | after 30 | after 3 | 85° C./85% | climatic |
| tape | Substrate | minutes | days | rel. humidity | cycling |
| 1 | Glass | 60 (C) | 62 (C) | 55 (C) | 61 (C) |
| 1 | Ceramic | 60 (C) | 61 (C) | 59 (C) | 60 (C) |
| | tile | | | | |
| 2 | Glass | 65 (C) | 66 (C) | 62 (C) | 62 (C) |
| 2 | Ceramic | 69 (C) | 69 (C) | 63 (C) | 58 (C) |
| | tile | | | | |

C = cohesive splitting of the adhesive tape

The composition of the primer comprising color pigments, while retaining the fundamental primer composition from example 4, was as follows:

### Example 4a

### Primer Composition

| Raw material/component | Mass percent |
|---|---|
| Primer PSA 1 (40.0 mass percent solids | 16.1 |
| fraction) | |
| Ethyl acetate | 69.9 |
| Geniosil ® XL 10 | 3.0 |
| Tyzor ® TPT | 7.0 |
| Printex ® 60 | 4.0 |

A layer of this primer 8 μm thick on glass was opaque. The transmittance in the wavelength range from 300 nm to 650 nm was 0%.

The primer was tested in the same way with the same test adhesive tapes as the color pigment-free primer from example 4, giving the same results—that is, in all cases the test adhesive tape underwent cohesive splitting.

### Example 5

### Primer Composition

| Raw material/component | Mass percent |
|---|---|
| Primer PSA 1 (40.0 mass percent solids fraction) | 16.7 |
| Ethyl acetate | 72.4 |
| Additive TI ® | 0.5 |
| Geniosil ® GF 80 | 3.1 |
| Tyzor ® TnBT | 7.3 |

The primer was tested with the test adhesive tapes, giving the following results:

| | | | | Peel adhesion after | |
|---|---|---|---|---|---|
| | | | | conditioned storage | |
| | | Peel adhesion | | (300 mm/min) (N/cm) | |
| Test | | (300 mm/min) (N/cm) | | a) 2 wks | b) 2 wks |
| adhesive | | after 30 | after 3 | 85° C./85% | climatic |
| tape | Substrate | minutes | days | rel. humidity | cycling |
| 1 | Glass | 62 (C) | 64 (C) | 59 (C) | 59 (C) |
| 1 | Ceramic | 63 (C) | 65 (C) | 57 (C) | 56 (C) |
| | tile | | | | |
| 2 | Glass | 66 (C) | 68 (C) | 61 (C) | 61 (C) |
| 2 | Ceramic | 69 (C) | 70 (C) | 62 (C) | 64 (C) |
| | tile | | | | |

C = cohesive splitting of the adhesive tape

The composition of the primer comprising color pigments, while retaining the fundamental primer composition from example 5, was as follows:

### Example 5a

### Primer Composition

| Raw material/component | Mass percent |
|---|---|
| Primer PSA 1 (40.0 mass percent solids fraction) | 16.0 |
| Ethyl acetate | 69.5 |
| Additive TI ® | 0.5 |
| Geniosil ® GF 80 | 3.0 |
| Tyzor ® TnBT | 7.0 |
| Printex ® 60 | 4.0 |

A layer of this primer 8 μm thick on glass was opaque. The transmittance in the wavelength range from 300 nm to 650 nm was 0%.

The primer was tested in the same way with the same test adhesive tapes as the color pigment-free primer from example 5, giving the same results—that is, in all cases the test adhesive tape underwent cohesive splitting.

### Example 6

### Primer Composition

| Raw material/component | Mass percent |
|---|---|
| Primer PSA 1 (40.0 mass percent solids fraction) | 16.7 |
| Ethyl acetate | 72.4 |
| Additive TI ® | 0.5 |
| Geniosil ® GF 80 | 3.1 |
| Tyzor ® AA-95 | 7.3 |

The primer was tested with the test adhesive tapes, giving the following results:

| | | | | Peel adhesion after | |
|---|---|---|---|---|---|
| | | | | conditioned storage | |
| | | Peel adhesion | | (300 mm/min) (N/cm) | |
| Test | | (300 mm/min) (N/cm) | | a) 2 wks | b) 2 wks |
| adhesive | | after 30 | after 3 | 85° C./85% | climatic |
| tape | Substrate | minutes | days | rel. humidity | cycling |
| 1 | Glass | 64 (C) | 65 (C) | 55 (C) | 60 (C) |
| 1 | Ceramic | 60 (C) | 65 (C) | 54 (C) | 58 (C) |
| | tile | | | | |
| 2 | Glass | 69 (C) | 69 (C) | 60 (C) | 63 (C) |
| 2 | Ceramic | 70 (C) | 72 (C) | 63 (C) | 66 (C) |
| | tile | | | | |

C = cohesive splitting of the adhesive tape

The composition of the primer comprising color pigments, while retaining the fundamental primer composition from example 6, was as follows:

### Example 6a

### Primer Composition

| Raw material/component | Mass percent |
|---|---|
| Primer PSA 1 (40.0 mass percent solids fraction) | 16.0 |
| Ethyl acetate | 69.5 |
| Additive TI ® | 0.5 |
| Geniosil ® GF 80 | 3.0 |
| Tyzor ® AA-95 | 7.0 |
| Printex ® 60 | 4.0 |

A layer of this primer 8 μm thick on glass was opaque. The transmittance in the wavelength range from 300 nm to 650 nm was 0%.

The primer was tested in the same way with the same test adhesive tapes as the color pigment-free primer from example 6, giving the same results—that is, in all cases the test adhesive tape underwent cohesive splitting.

### Example 7

### Primer Composition

| Raw material/component | Mass percent |
|---|---|
| Primer PSA 1 (40.0 mass percent solids fraction) | 16.7 |
| Ethyl acetate | 72.4 |
| Additive TI ® | 0.5 |
| Geniosil ® GF 80 | 3.1 |
| Tyzor ® NBZ | 7.3 |

The primer was tested with the test adhesive tapes, giving the following results:

| | | | | Peel adhesion after | |
|---|---|---|---|---|---|
| | | | | conditioned storage | |
| | | Peel adhesion | | (300 mm/min) (N/cm) | |
| Test | | (300 mm/min) (N/cm) | | a) 2 wks | b) 2 wks |
| adhesive | | after 30 | after 3 | 85° C./85% | climatic |
| tape | Substrate | minutes | days | rel. humidity | cycling |
| 1 | Glass | 64 (C) | 68 (C) | 64 (C) | 60 (C) |
| 1 | Ceramic | 65 (C) | 70 (C) | 60 (C) | 62 (C) |
| | tile | | | | |
| 2 | Glass | 64 (C) | 67 (C) | 64 (C) | 60 (C) |
| 2 | Ceramic | 66 (C) | 69 (C) | 60 (C) | 63 (C) |
| | tile | | | | |

C = cohesive splitting of the adhesive tape

The composition of the primer comprising color pigments, while retaining the fundamental primer composition from example 7, was as follows:

### Example 7a

### Primer Composition

| Raw material/component | Mass percent |
|---|---|
| Primer PSA 1 (40.0 mass percent solids fraction) | 16.0 |
| Ethyl acetate | 69.5 |
| Additive TI ® | 0.5 |
| Geniosil ® GF 80 | 3.0 |
| Tyzor ® NBZ | 7.0 |
| Printex ® 60 | 4.0 |

A layer of this primer 8 μm thick on glass was opaque. The transmittance in the wavelength range from 300 nm to 650 nm was 0%.

The primer was tested in the same way with the same test adhesive tapes as the color pigment-free primer from example 7, giving the same results—that is, in all cases the test adhesive tape underwent cohesive splitting.

Additionally it was possible to incorporate the fluorescent optical brightener in a functional concentration in all examples without any deterioration in the adhesion-promoting effect. This functional concentration was selected at 1.5 mass percent, based on the solvent-free fraction of the primer.

### Comparative Example 1

### Comparative Primer Composition

| Raw material/component | Mass percent |
|---|---|
| Primer PSA 4 (40.0 mass percent solids fraction) | 16.7 |
| Ethyl acetate | 72.4 |
| Additive TI ® | 0.5 |
| Geniosil ® GF 80 | 3.1 |
| Tyzor ® TPT | 7.3 |

The primer was tested in the following way with the test adhesive tapes, giving the following results:

| | |
|---|---|
| | Peel adhesion |
| Test | (300 mm/min) (N/cm) |

| adhesive | | after 30 | after 3 |
|---|---|---|---|
| tape | Substrate | minutes | days |
| 1 | Glass | 8 (A) | 20 (A) |
| 1 | Ceramic | 13 (A) | 16 (A) |
| | tile | | |
| 2 | Glass | 7 (A) | 15 (A) |
| 2 | Ceramic | 12 (A) | 22 (A) |
| | tile | | |

A = adhesive detachment of the adhesive tape

### Comparative Example 2

### Comparative Primer Composition

| Raw material/component | Mass percent |
|---|---|
| Primer PSA 1 (40.0 mass percent solids fraction) | 16.7 |
| Ethyl acetate | 19.0 |
| Toluene | 50.0 |
| Additive TI ® | 0.5 |
| Geniosil ® GF 80 | 3.1 |
| Tyzor ® TPT | 7.3 |
| Kraton ® D 1102 E | 3.4 |

The primer was tested in the following way with the test adhesive tapes, giving the following results:

| | |
|---|---|
| | Peel adhesion |
| Test | (300 mm/min) (N/cm) |

| adhesive | | after 30 | after 3 |
|---|---|---|---|
| tape | Substrate | minutes | days |
| 1 | Glass | 6 (A) | 18 (A) |
| 1 | Ceramic | 9 (A) | 13 (A) |
| | tile | | |
| 2 | Glass | 9 (A) | 27 (A) |
| 2 | Ceramic | 11 (A) | 18 (A) |
| | tile | | |

A = adhesive detachment of the adhesive tape

### Comparative Example 3

### Comparative Primer Composition

| Raw material/component | Mass percent |
|---|---|
| Primer PSA 1 (40.0 mass percent solids fraction) | 16.7 |
| Ethyl acetate | 19.9 |
| Toluene | 50.0 |
| Additive TI ® | 0.5 |
| Geniosil ® GF 80 | 3.1 |
| Tyzor ® TPT | 7.3 |
| Kraton ® G 1652 E | 2.5 |

The primer was tested in the following way with the test adhesive tapes, giving the following results:

| | |
|---|---|
| | Peel adhesion |
| Test | (300 mm/min) (N/cm) |

| adhesive | | after 30 | after 3 |
|---|---|---|---|
| tape | Substrate | minutes | days |
| 1 | Glass | 7 (A) | 25 (A) |
| 1 | Ceramic | 11 (A) | 19 (A) |
| | tile | | |
| 2 | Glass | 10 (A) | 20 (A) |
| 2 | Ceramic | 11 (A) | 19 (A) |
| | tile | | |

A = adhesive detachment of the adhesive tape

1. A primer comprising a mixture G which is dispersed or dissolved in one or more solvents and comprises:
at least one copolymer obtained by copolymerization of a monomer mixture comprising to an extent of at least 90 wt % the following monomers: vinylcaprolactam and/or vinylpyrrolidone and one or more of the monomers a) and/or b):
a) acrylic esters of a linear, primary alcohol having 2 to 10 carbon atoms in the alkyl radical of the alcohol,
b) acrylic esters of a branched, noncyclic alcohol having 3 to 12 carbon atoms in the alkyl radical of the alcohol,
at least one organofunctional silane of the general structure (I)
(R¹O—)ₓSi(R²)_{y}(R³)_{z} (I), in which
the radicals R¹ independently of one another are a C₁-C₄ alkyl radical, a C₂-C₆ alkoxyalkyl radical or an acetyl radical;
the radical R² is an aminoalkyl radical, a vinyl group, a methacryloyloxyalkyl radical, an isocyanatoalkyl radical, an O-methylcarbamatoalkyl radical, a glycidyloxyalkyl radical or a phenyl radical;
the radicals R³ independently of one another are a C₁-C₁₈ alkyl radical, and x=1, 2 or 3; y=0 or 1, and z=4−x−y;
at least one metal compound selected from the group consisting of metal acetylacetonates, metal alkoxides, and alkoxy-metal acetylacetonates.

2. The primer as claimed in claim 1, wherein the copolymer is a pressure sensitive adhesive.

3. The primer as claimed in claim 1, wherein the sum of the weight fractions of vinylcaprolactam and vinylpyrrolidone in the monomer mixture is not more than 50 wt %, based on the total weight of the monomer mixture.

4. The primer as claimed in claim 1, wherein the monomer mixture comprises at least 10 wt % of vinylcaprolactam and/or vinylpyrrolidone, based on the total weight of the monomer mixture.

5. The primer as claimed in claim 1, wherein the monomer mixture comprises at most 1 wt % of acrylic acid, based on the total weight of the monomer mixture.

6. The primer as claimed in claim 1, wherein the monomer mixture comprises n-butyl acrylate.

7. The primer as claimed in claim 1, wherein the weight fraction of the entirety of all metal compounds in the mixture G is greater than the weight fraction of the entirety of all organofunctional silanes of the general structure (I).

8. The primer as claimed in claim 1, wherein the metal of the metal compound is selected from the group consisting of titanium, aluminum, zirconium, zinc, and iron.

9. The primer as claimed in claim 1, wherein the radical R² in the general structure (I) is a glycidyloxyalkyl radical and y=1.

10. The primer as claimed in claim 1, wherein tosyl isocyanate (CAS No. 4083-64-1) was admixed to the primer during its preparation.

11. The primer as claimed in claim 1, wherein the concentration of the copolymer, based on the total weight of the primer, is from 1 wt % inclusive to 30 wt % inclusive.

12. The primer as claimed in claim 1, wherein the primer comprises one or more fluorescent optical brighteners.

13. A method for producing an adhesion-promoting layer, which comprises producing said adhesion-promoting layer with a primer of claim 1.

14. A method for producing an adhesion-promoting layer on a substrate, comprising the application of a primer as claimed in claim 1 to a substrate and the removal of the one or more solvents.
